(19) United States
(12) Patent Application Publication
(10) Pub. No.: US 2009/0171710 A1
(43) Pub. Date: Jul. 2, 2009

(54) Mobile Advertisement System With Advertisement Status

(75) Inventors: Musiri Shrivathsan, San Jose, CA (US); Nicola A. Crane, San Francisco, CA (US); Salman Dhanani, Redmond, WA (US)

Correspondence Address: LAW OFFICES OF MIKIO ISHIMARU, 333 W. EL CAMINO REAL, SUITE 330, SUNNYVALE, CA, 94087, US

(73) Assignee: TELENAV, INC., Sunnyvale, CA (US)

(21) Appl. No.: 11/966,992

(22) Filed: Dec. 29, 2007

(51) Int. Cl. G06Q 30/00

(52) U.S. Cl. 705/7; 705/14

(57) ABSTRACT

A method of operating a mobile advertisement system includes receiving an advertisement parameter by a client from a server to be shown on a display of the client; detecting an advertisement control parameter with the advertisement parameter in the client; operating the client based on the advertisement control parameter and the advertisement parameter; creating an advertisement status parameter based on the advertisement parameter in the client; and sending the advertisement status parameter from the client to the server.

### TECHNICAL FIELD

The present invention relates generally to a location based service system, and more particularly, to a mobile client navigation system having a mobile advertisement system, wherein a mobile client and a server communicate to carry out navigation tasks.

### BACKGROUND ART

Modern portable consumer electronics, especially client devices such as navigation systems, cellular phones, portable digital assistants, and combination devices, are providing increasing levels of functionality to support modern life including location-based information services. Numerous technologies have been developed to utilize this new functionality. Some of the research and development strategies focus on new technologies while others focus on improving the existing and mature technologies. Research and development in the existing technologies may take a myriad of different directions.

As consumers become more empowered with the growth of mobile location based service devices, new and old marketing paradigms begin to take advantage of this new device space. There are many technological solutions to take advantage of this new device location opportunity. One possible approach can be to provide location sensitive advertisement messages that allow advertisement providers to generate more highly targeted and more individually effective advertisements to users. However, the ability for the advertisers to highly target their potential customers on their mobile, device having location based services does not automatically translate to being an effective marketing or advertisement campaign.

Thus, a need remains for a mobile location based advertisement system to efficiently reach target customers. In view of the ever-increasing added features desired by consumers in their mobile client devices, it is more and more critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operating a mobile advertisement system including receiving an advertisement parameter by a client from a server to be shown on a display of the client; detecting an advertisement control parameter with the advertisement parameter in the client; operating the client based on the advertisement control parameter and the advertisement parameter; creating an advertisement status parameter based on the advertisement parameter in the client; and sending the advertisement status parameter from the client to the server.

Certain embodiments of the invention have other aspects in addition to or in place of those mentioned above. The aspects will become apparent to those skilled in the art from a reading of the following detailed description when taken with reference to the accompanying drawings.

### BRIEF DESCRIPTION OF THE DRAWINGS

FIG. 1 illustrates a mobile advertisement system in an embodiment of the present invention;

FIG. 2 is a block diagram of the mobile advertisement system of FIG. 1;

FIG. 3 is a flow chart of the mobile advertisement system of FIG. 1;

FIG. 4 is a flow chart of the advertisement, and route status system of FIG. 1;

FIG. 5 is a block diagram of the advertisement server system of FIG. 1;

FIGS. 6A and 6B are illustrations of ads displayed by the client with the mobile advertisement system;

FIGS. 7A and 7B are illustrations of an advertisement selection and related content by the client with the mobile advertisement system; and

FIG. 8 is a flow chart of a method for operating the mobile advertisement system in an embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present, disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the system are semi-diagrammatic and not to scale and, particularly, some of the dimensions are for the clarity of presentation and are shown greatly exaggerated in the drawing FIGs. The term “system” as used herein means and refers to the method and to the apparatus of the present invention in accordance with the context in which the term is used.

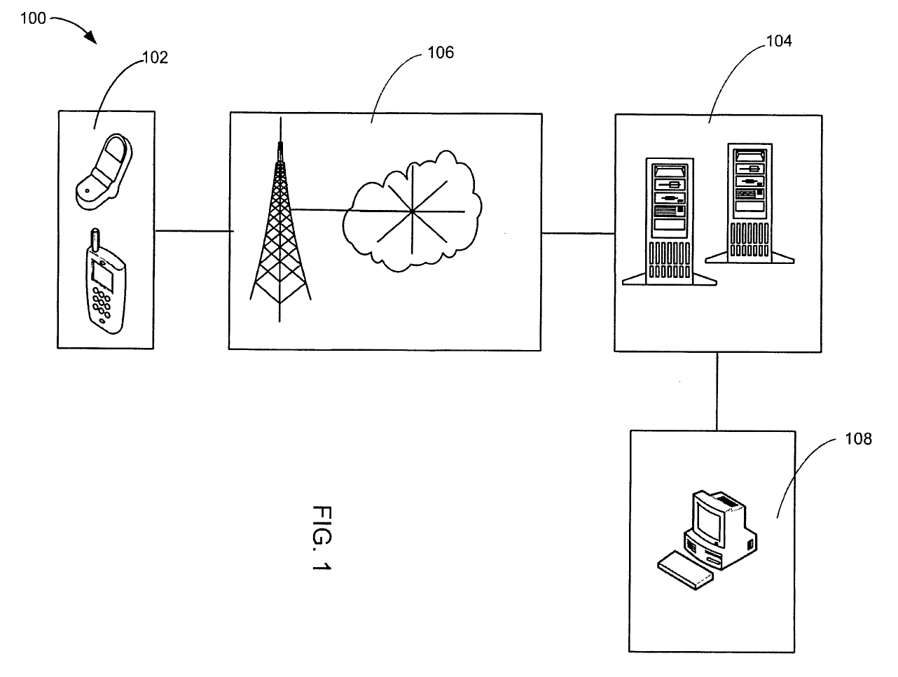

Referring now to FIG. 1, therein is illustrated a mobile advertisement system 100 in an embodiment of the present invention. A client 102 is connected to a communication path 106, such as a wireless telecommunication network, to a server 104. As used herein, the client 102 can be of any of a variety of mobile devices, such as a cellular phone, personal digital assistant, a notebook computer, or other multi-functional mobile communication or entertainment devices having means to couple to a communication path to communicate with a server and means for client location monitoring, preferably, global positioning system (GPS) function.

The client 102 includes, for example, a control device (not shown), such as a microprocessor, software (not shown), a memory (not shown), communication components (not shown), location monitoring components (not shown), and a user interface. The user interface, such as a display, a key pad, touchpad, a microphone, and a speaker, allows the user to interact with the client 102 and to provide advertisement status inputs. The microprocessor executes the software and provides the intelligence of the client 102 for interaction with the server 104 for relevant information, for the user interface, for interaction with the communication path 106, and interaction to the location monitoring system of the client 102, as well as other functions pertinent in a location based service communication device.

The memory, such as volatile, nonvolatile memory, internal only, externally upgradeable, or a combination thereof, may store the software, setup data, and other data for the operation of the client 102 as a mobile location based service communication device. The memory may also store the relevant information, such as maps, route information, traffic information, advertisement and point of interest (POT), etc., from the server 104 or may be preloaded. The memory may also store the sampled or created relevant information to be transmitted to the server 104.

For example, the functions of the client 102 may be performed by software, firmware, hardware, or a combination thereof. The communication components can include active and passive components, such as microelectronics or an antenna, for interaction to the cellular system of the communication path 106. The navigation components can include the active and passive components, such as microelectronics or an antenna, for interaction with the communication path 106.

The communication path 106 can be of any of a variety of telecommunication networks. For example, the communication path 106 may include wireless communication, wired communication, or the combination thereof. Satellite communication, cellular communication, wireless fidelity (WiFi), and worldwide interoperability for microwave access (WiMAX) are examples of wireless communication that may be included in the communication path 106. Ethernet, digital subscriber line (DSL), fiber to the home (FTTH), and plain old telephone service (POTS) are examples of wired communication that may be included in the communication path 106. Further, the communication path 106 may traverse a number of network topologies and distances. For example, the communication path 106 may include personal area network (PAN), local area network (LAN), metropolitan area network (MAN), and wide area network (WAN).

The server 104 can include a number of devices, for example, a control device (not shown), such as a microprocessor, software (not shown), a memory, communication components (not shown), location monitoring components (not shown), and a user interface. The microprocessor executes the software and provides the intelligence of the server 104 for interaction with the client 102, interaction to the communication system of the communication path 106 and interaction with a server user interface 108.

For illustrative, purposes, the server 104 is shown in a single location, although it is understood that the server may be located at different locations. For example, the server 104 may represent servers in a single computer room, and distributed across different rooms or geographical locations. Also for illustrative purposes, the server 104 and the server user interface 108 are shown as separate and discrete components, although it is understood that the server user interface 108 may by included in the server 104. Further for illustrative purposes, the server user interface 108 is shown coupled to the server 104, although it is understood that the server user interface 108 may couple to the server 104 differently. For example, the server user interface 108 may interact with the communication path 106 to communicate with the server 104.

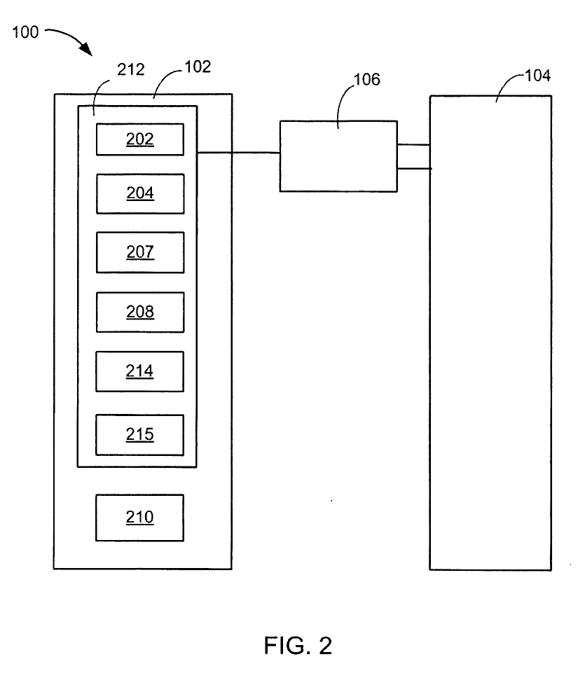

Referring now to FIG. 2, therein is shown a block diagram of the mobile advertisement system 100 of FIG. 1. The client 102 couples with the communication path 106 to send a server request 202 to the server 104. In response to the server request 202, the client 102 receives advertisement parameters 204 from the server 104 over the communication path 106. The client 102 couples with the communication path 106 to send an advertisement status parameter 207 to the server 104

For example, the advertisement parameters 204 include control and data parameters for controlling the operation of a display 210 of the client 102, preferably in association with displaying navigation route data received by the client 102. As further described later, the advertisement parameters 204 may include control and data parameters for controlling the operation of the display 210 in association with a variety of navigation events, such as in association with notifying a user of navigational directions, of location-based information or messaging, such as relating to traffic data, point of interests, advertisements, special offers or coupons as an example.

The client 102 may store the advertisement parameters 204 in a local storage 212. The local storage 212 may be implemented in a number of ways. For example, the local storage 212 may be a nonvolatile storage such as non-volatile random access memory (NVRAM) or a volatile storage such as static random access memory (SRAM). The advertisement parameters 204 preferably include locally stored control and data parameters for controlling the operation of the display 210 of the client 102, preferably in association with displaying navigation related to the advertisement parameters 204 received by the client 102 from the server 104 via the communication path 106

As further described later, the advertisement parameters 204 include an advertisement control parameter 214 for controlling the display 210 of navigation and advertisement events including location specific advertisements, navigational directions, location-based information or messaging, such as coupons or special offers for a local establishment.

The client 102 may accept input from the user control, such as a key entry, to select one or a portion of the advertisement parameters 204 to generate an advertisement status update for the advertisement parameters 204 to send to the server 104 to annotate the advertisement status parameter 207 for the advertisement parameters 204. The updated information from the advertisement status parameter 207 can be used by the server 104 to compute billing information, usage information, or a combination thereof for the selected portion of the advertisement parameters 204.

A navigation unit 215 in the client 102 may automatically generate an advertisement status update to provide the advertisement status parameter 207 for an advertisement parameters 204 to send to the server 104 to annotate the advertisement status parameter 207 for the advertisement parameters 204. The updated information from the advertisement status parameter 207 can be used by the server 104 to compute billing information, usage information, or a combination thereof for the selected portion of the advertisement parameters 204

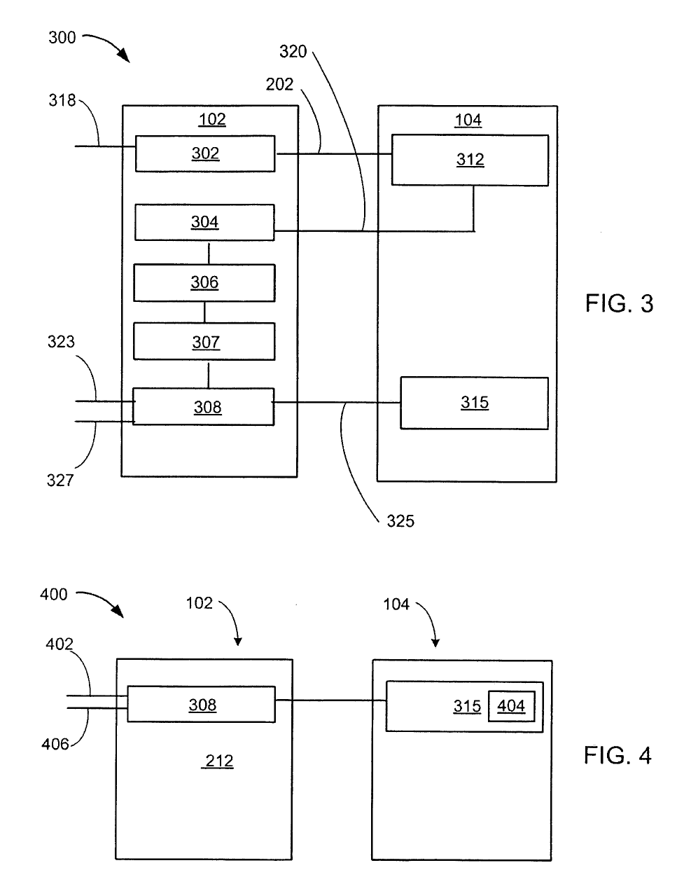

Referring now to FIG. 3, therein shown is a flow chart 300 of the mobile advertisement system 100 of FIG. 1. In operation, for example, the client 102 preferably receives a destination request 318 from the user input means (not shown) and sends the server request 202 via the communication path 106 of FIG. 1 to the server 104 in a block 302. The server 104 receives the server request 202 from the client 102 and generates the advertisement parameters 204 of FIG. 2 and sends an advertisement response 320 containing the advertisement parameters 204 to the client 102 via the communication path 106 in a block 312. The advertisement parameters 204 may include any number of parameters, such as text, images, audio, video, location parameters, date, time, duration, control actions, display parameters, coupons, special offers, or any combination thereof.

The client 102 receives the advertisement response 320 containing the advertisement parameters 204 from the server 104 over the communication path 106 in a block 304. The client 102 preferably detects the advertisement control parameter 214 for use with the advertisement parameters 204 from the advertisement response 320 and operates the display 210 of FIG. 2 of the client 102 in a block 306.

The client 102 preferably operates in an advertisement display mode determined by an advertisement control parameter 214 and displays a portion of the advertisement parameters 207 on the display 210 in any number of display modes, such as three dimensional billboard, flat billboard, banner advertisement, full screen advertisement, audio clip, video clip, text message, scrolling message box, popup message, mixed multimedia presentation or any combination thereof in a block 307.

The client 102 operates in an advertisement display mode determined by an advertisement control parameter 214 and displays the advertisement parameters 204 on the display 210 in any number of background display modes, such as a stationary map, moving map, split screen, full screen, segmented, route-based, free-driving based or any combination thereof in a block 307.

The client 102 receives an location update 327 with the navigation unit 215 and operates with an advertisement display mode determined by an advertisement control parameter 214 and displays a highlighted portions of the advertisement parameters 204 on the display 210 if the location parameter of the advertisement parameters 204 satisfies a criteria such as within a range while moving, within a range while stationary, unique advertisement type on map, preferential advertisement for region, preferential advertisement for route, preferential advertisement type, preferential advertisement for lime period, preferential advertisement for environmental conditions, or any combination thereof in a block 308.

The client 102 preferably receives an advertisement selection input 323 from the user input means (not shown) for a selected portion of the advertisement parameters 204 and displays a alternative advertisement display, such as WAP page, SMS message, coupon, full screen advertisement, audio clip, video clip, interactive text message, mixed multimedia presentation or any combination thereof, on the display 210 in a block 308.

The server 104 receives the advertisement status request 325 from the block 308 of the client 102 and stores the advertisement status parameter 207 in the data storage in a block 315. The advertisement status parameter 207 can be used to compute billing information, usage information, or a combination thereof for the selected portion of the advertisement parameters 204.

For illustrative purposes, the server 104 is described as providing the advertisement parameters 204 to the client 102 as a response to the server request 202 resulting from the destination request 318, although it is understood that the server 104 may provide different responses. For example, the server 104 may provide local service or business information, coupons, and location reminder information in addition to the advertisement parameters 204.

Referring now to FIG. 4, therein shown is a flow chart 400 of the manual and automatic status update modes of the mobile advertisement system 100 of FIG. 1. In operation, for example, the client 102 can operate in a manual advertisement status mode determined by the advertisement control parameter 214 of FIG. 2. The client 102 preferably receives a manual advertisement status input 402 from the user input means (not shown) when an advertisement is selected and sends the advertisement status parameter 207 of FIG. 2 with the manual advertisement status input 402 via the communication path 106 of FIG. 1 to the server 104 in the block 308.

The server 104 receives the advertisement status parameter 207 with the manual advertisement status input 402 and stores it in a server storage 404, such as disk storage or server main memory, in the block 315. The advertisement status parameter 207 may include any number of parameters, such as an advertisement selection status, manual advertisement status value, time, date, a current location vs. advertisement location status value, or any manner of advertisement interaction status parameter including coupon selected, uniform or universal resource locator (URL) selected, supplemental advertisement viewed, navigation route request, or a combination thereof.

The client 102, for example, can operate in an automatic advertisement status mode determined by the advertisement control parameter 214 and generate an automatic advertisement status input 406 automatically based on current location and advertisement location for advertisements that are available in the local storage 212 of the client 102. The advertisement status parameter 207 with the automatic advertisement status input 406 is sent via the communication path 106 of FIG. 1 to the server 104 in the block 308. The server 104 receives the advertisement status parameter 207 with the automatic advertisement status input 406 and stores it in the server storage 404 in the block 315.

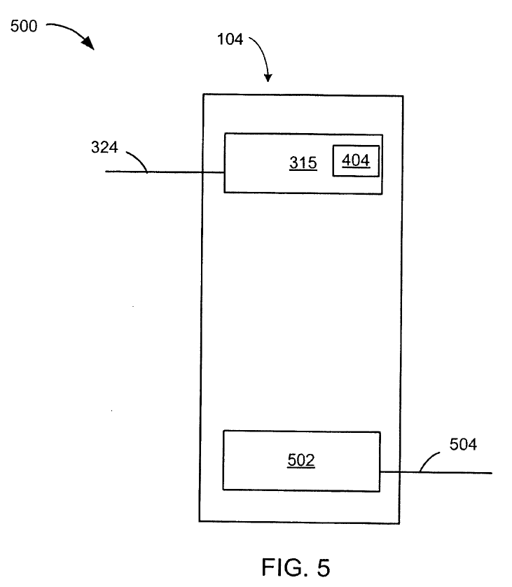

Referring now to FIG. 5, therein shown is a flow chart 500 of the server 104 of the mobile advertisement system 100 of FIG. 1. In operation, for example, the server 104 preferably receives the advertisement status request 324 from the client 102 of FIG. 1 via the communication path 106 of FIG. 1. The advertisement status request 324 can include the advertisement status parameter 207 in the block 315. The server 104 can store the advertisement status parameter 207 in the server storage 404 that can later be used to update the advertisement parameters 204 based on the advertisement, status parameter 207.

The server 104 in another example can receive a server user input 504, such as from the server user interface 108 of FIG. 1, including the advertisement parameters 204 that may be stored in the server storage 404. The advertisement parameters 204 may include, any number of parameters such as advertisement bid type, bid price, bid criteria, bid location, bid route, bid WAP page, bid time period, text, images, SMS messages, audio, video, location parameters, date, time, duration, control actions, display parameters, coupons, special offers, or any combination thereof. The advertisement parameters 204 in the server storage 404 may be used to generate a set of the advertisement parameters 204 stored in the block 312 of FIG. 3. Selected portions of the advertisement parameters 204 may be based on criteria such as location, route, date, time, user preferences, advertisement status, advertisement price, special status values, vendor bidding, status statistics, threshold values for any of the fore mentioned parameters, or a combination thereof.

The server 104, preferably provide an advertisement management system 502 that can generate reports showing data such as advertisement status, use, quality, type of status or any combination thereof. The server 104 can receive the server user input 504 and provide advertisement management control commands to control and manage the advertisement management system 502.

The server 104 in another example can provide a billing function based on the advertisement bid type and the advertisement status parameter 207 of a portion of the advertisement parameters 204 that can provide a billing cost entry to be stored in the server data storage 404 for the advertisement parameters 204. The billing type can consist of any type of bidding or predetermined methodology such as payment per click on a related WAP display page, payment per click on a related phone number and subsequent phone call, payment per impression, payment per navigation to advertisement location, payment per navigation near a displayed advertisement, payment per displayed map related to an advertisement, payment per shared address related to an advertisement, payment per interaction with an advertisement, or any combination thereof.

Referring now to FIGS. 6A and 6B, therein are illustrations of ads displayed by the client 102 with the mobile advertisement system 100. For example, a navigation path with segments R1, R2, R3 are shown on the display 210 of the client 102 of the mobile advertisement system 100 of FIG. 1. For example, navigation from the starting point S1 to the destination D1, the client 102 can display a moving map and display three-dimensional advertisements on the current route segment.

In FIG. 6A, the advertisement parameters 204 include an advertisement location at a proximate location to the current location of the client 102 on route R1. The client 102 displays a three dimensional advertisement P2 on the display 210. By displaying the advertisement parameters 204 within a predetermined region to the client 102, an automatic advertisement status parameter 207 can be sent via the communication path 106 of FIG. 1 to the server 104 of FIG. 1. The advertisement status parameter 207 can incorporate several types of information such as distance to location, time, date, speed, selection status, click status, related content status or any combination thereof. In FIG. 6B, the next advertisement P1 is shown when the advertisement location of the advertisement parameters 204 is close to the current location of the client 102.

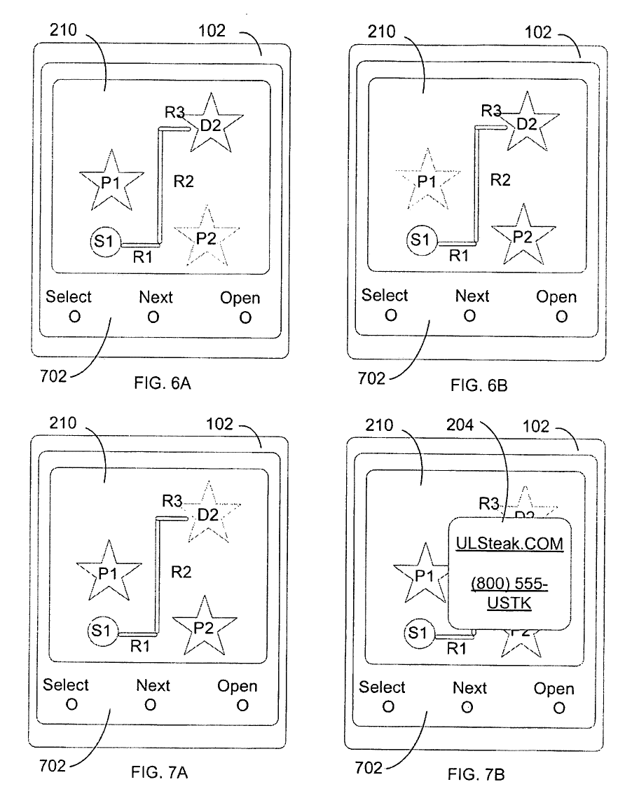

Referring now to FIG. 7A and FIG. 7B, therein are illustrations of an advertisement selection and related content by the client 102 with the mobile advertisement system 100 of FIG. 1. In FIG. 7A, the advertisement parameters 204 include an advertisement location that is co-located with the current location of the client 102 indicating that the client 102 has navigated to the advertisement location. The advertisement status parameter 207 can be sent, automatically via the communication path 106 to the server 104 to indicate a completed navigation to an advertisement location for the portion of the advertisement parameters 204 potentially invoking a billable event to the business for the selected portion of the advertisement parameters 204. The billable event can be performed automatically, selectively, or manually.

For example, the server 104 can update the advertisement parameters 204 based on the advertisement status parameter 207 and send the update to the client 102. The update received by the client 102 may modify advertisement control parameter 214, the advertisement status parameter 207, or a combination thereof. The client 102 can disable the advertisement status parameter 207, such as prohibiting multiple or inadvertent billing event for the same business or advertisement transaction.

In FIG. 7B, the client 102 has selected an advertisement P1 representing a portion of the advertisement parameters 204 and displays a three dimensional billboard with a URL WAP link and a phone link. The client 102 can select the URL WAP link and display a WAP landing page related to the portion of the advertisement parameters 204. An automatic advertisement status parameter 207 can be sent via the communication path 106 to the server 104 of to indicate a click to related WAP page billing event for advertisement parameter 204. The client 102 can select the phone link and initiate a phone call related to the advertisement parameter 204. The advertisement status parameter 207 can be automatically sent to the server 104 of to indicate a click to phone billing event for the advertisement parameters 204. The advertisement status parameter 207 can be sent to the server 104 of to indicate a click to phone billing event for advertisement parameter 204. The client 102 can select an option to display local search results related to the advertisement parameter 204.

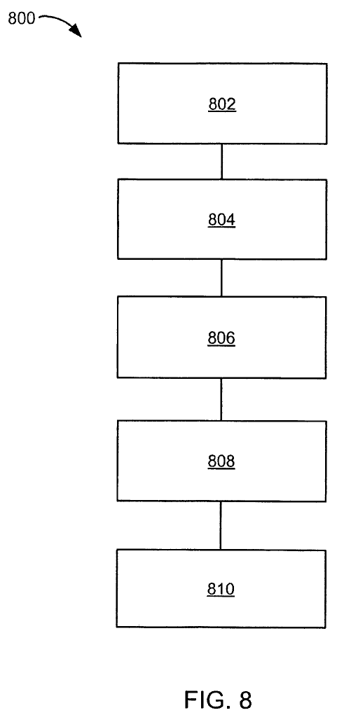

Referring now to FIG. 8, therein is shown a flow chart of a method 800 for operating the mobile advertisement system 100 in an embodiment of the present invention. The method 800 including receiving an advertisement parameter by a client from a server to be shown on a display of the client in a block 802; detecting an advertisement control parameter with the advertisement parameter in the client in a block 804; operating the client based on the advertisement control parameter and the advertisement parameter in a block 806; creating an advertisement status parameter based on the advertisement parameter in the client in a block 808; and sending the advertisement status parameter from the client to the server in a block 810.

Yet another important aspect of the present invention is that it valuably supports and services the historical trend of reducing costs, simplifying systems, and increasing performance.

These and other valuable aspects of the present invention consequently further the state of the technology to at least the next level.

Thus, it has been discovered that the mobile advertisement system of the present invention furnishes important and heretofore unknown and unavailable solutions, capabilities, and functional aspects for improving yield, increasing reliability, and reducing cost of mobile client having location based services capability. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with a specific best mode, it is to be understood that many alternatives, modifications, and variations will be apparent, to those skilled in the art in light of the foregoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A method for operating a mobile advertisement system comprising:
receiving an advertisement parameter by a client from a server to be shown on a display of the client;
detecting an advertisement control parameter with the advertisement parameter in the client;
operating the client based on the advertisement control parameter and the advertisement parameter;
creating an advertisement status parameter based on the advertisement parameter in the client; and
sending the advertisement status parameter from the client to the server.

2. The method as claimed in claim 1 further comprising modifying the advertisement parameter at the server based on the advertisement status parameter.

3. The method as claimed in claim 1 wherein sending the advertisement status parameter from the client to the server includes automatically sending the advertisement status parameter based on the client at a business location for the advertisement parameter.

4. The method as claimed in claim 1 wherein creating the advertisement status parameter based on the advertisement parameter in the client includes detecting the location of the client with a navigation unit in the client.

5. The method as claimed in claim 1 wherein creating the advertisement status parameter based on the advertisement parameter in the client includes creating a billable event with the advertisement status parameter.

6. The method as claimed in claim 1 wherein receiving the advertisement parameter by the client to be shown on the display includes displaying a three-dimensional rendition of the advertisement parameter on the display.

7. The method as claimed in claim 1 wherein receiving the advertisement parameter by the client to be shown on the display includes displaying a selected portion of the advertisement parameter on the display.

8. The method as claimed in claim 1 wherein creating the advertisement status parameter based on the advertisement parameter in the client includes creating the advertisement status parameter based on the advertisement control parameter.

9. The method as claimed in claim 1 further comprising sending the advertisement parameter based on the advertisement status parameter from the server to the client.

10. The method as claimed in claim 1 further comprising:
sending the advertisement parameter based on the advertisement status parameter from the server to the client; and
modifying the advertisement control parameter in the client.

11. A method for operating a mobile advertisement system comprising:
receiving an advertisement parameter by a client, having a navigation and location based services functions, from a server to be shown on a display of the client;
detecting an advertisement control parameter with the advertisement parameter in the client;
operating the client based on the advertisement control parameter and the advertisement parameter;
creating an advertisement status parameter based on the advertisement parameter in the client;
sending the advertisement status parameter from the client to the server; and
modifying the advertisement parameter based on the advertisement status parameter in the server.

12. The method as claimed in claim 11 wherein detecting the advertisement control parameter includes controlling the display in a predetermined mode.

13. The method as claimed in claim 11 wherein creating the advertisement status parameter includes creating the advertisement status parameter for a destination point of interest or an alternate point of interest.

14. The method as claimed in claim 11 wherein sending the advertisement status parameter from the client to the server includes sending the advertisement status parameter for a destination point of interest or an alternate point of interest.

15. The method as claimed in claim 11 wherein sending the advertisement status parameter from the client to the server includes sending the advertisement status parameter at a destination point of interest.

16. The method as claimed in claim 11 wherein receiving the advertisement parameter by the client to be shown on the display includes displaying a three-dimensional rendition of the advertisement parameter on the display.

17. The method as claimed in claim 11 wherein modifying the advertisement parameter based on the advertisement status parameter in the server includes sending a modified advertisement parameter to the client.

18. The method as claimed in claim 11 wherein modifying the advertisement parameter based on the advertisement status parameter in the server includes disabling the advertisement status parameter at the client with a modified advertisement parameter from the server.

19. The method as claimed in claim 11 wherein modifying the advertisement parameter based on the advertisement status parameter in the server includes modifying the advertisement control parameter at the client with a modified advertisement, parameter from the server.

20. The method as claimed in claim 11 wherein receiving the advertisement parameter by the client to be shown on the display includes displaying a coupon on the display.
